(19) United States
(12) Patent Application Publication
(10) Pub. No.: US 2015/0220706 A1
(43) Pub. Date: Aug. 6, 2015

(54) Tailored Rapid Interactive Mobile Messaging (TRIMM) for Weight Management

(71) Applicant: THE JOHNS HOPKINS UNIVERSITY, Baltimore,, MD (US)

(72) Inventors: Michael Lin, Baltimore, MD (US); Lawrence Cheskin, Ellicott City, MD (US)

(21) Appl. No.: 14/429,794

(22) PCT Filed: Sep. 20, 2013
(86) PCT No.: PCT/US2013/060870

§ 371 Date: Mar. 20, 2015

Related U.S. Application Data
(60) Provisional application No. 61/771,128, filed on Mar. 1, 2013.
(60) Provisional application No. 61/703,750, filed on Sep. 20, 2012.

(51) Int. Cl. G06F 19/00; H04W 4/02

(52) U.S. Cl. CPC G06F 19/363; H04W 4/02; G06F 19/3481; G06F 19/3475

(57) ABSTRACT

An embodiment in accordance with the present invention provides a system and a method for facilitating a user to meet a self-selected goal. The user enrolls in the program and receives a tailored series of motivational text messages. The text messages can be individualized for the user based on user goals, responses to pull text messages, responses to questionnaires, and the user's preferred style of receiving information. These text messages help to guide the user to reach the goal by encouraging and reminding the user to engage in desired behaviors. The system and method are described with respect to an exemplary embodiment for encouraging weight loss, but can also be used for other applications, such as diabetes control and smoking cessation.

### CROSS REFERENCE TO RELATED APPLICATIONS

This application claims the benefit of U.S. Provisional Patent Application Nos., 61/703,750, filed Sep. 20, 2012, and 61/771,128, filed Mar. 1, 2013 which are incorporated by reference herein, in their entirety.

### FIELD OF THE INVENTION

The present invention relates generally to weight management. More particularly the present invention relates to a tailored mobile messaging system for weight management.

### BACKGROUND OF THE INVENTION

Weight loss and weight maintenance are key to battling and preventing obesity. While weight loss products and programs form a billion dollar a year industry, many of the most effective programs and products are prohibitively expensive for a large percentage of the population. Indeed, this poorer, underserved population has the highest rates of obesity and its complications, and most needs affordable weight loss solutions. Physicians, in particular, currently lack cost conscious effective, empirically-supported models of treatment to help obese patients lose weight. Existing obesity interventions are costly and often intrusive, and their adoption and effectiveness have not kept up with the rising prevalence of obesity and its co-morbidities. Additionally, many of these existing interventions are either unavailable to underserved populations or financially out of reach.

It would therefore be advantageous to public health to provide a method and system to promote and encourage weight-loss that is cost conscious, effective, and accessible.

### SUMMARY OF THE INVENTION

The foregoing needs are met, to a great extent, by the present invention, wherein in one aspect a series of messages is configured to motivate a user to engage in behaviors that support losing weight, wherein said messages take the form of pull messages, configured to request personal information from the user, and push messages, configured to deliver personalized information to the user. Personal information is solicited from the user by sending pull messages to the user. The push messages sent to the user are tailored with the personal information gained in the pull messages. The user is therefore motivated to meet a weight loss goal by adjusting the language of the pull and push messages based on the personal information from the user, simulating a live interaction with a health coach or health care provider.

In accordance with an aspect of the present invention, a method of promoting a goal for a user includes configuring a series of messages regarding the goal to be directed to the user, wherein said messages take the form of pull messages, configured to request personal information from the user, and take the form of push messages configured to deliver personalized information to the user. The method also includes soliciting the personal information from the user by sending pull messages from the series of messages to the user. The push messages sent to the user are tailored with the personal information gained in the pull messages. Additionally, the method includes motivating the user to meet a goal by adjusting the language of the push and pull messages based on the personal information from the user.

In accordance with yet another aspect of the present invention, a system for helping a user to meet a goal includes a computing device configured to transmit motivational text messages to the user on a personal device. A database includes the motivational text messages to be sent to the user, and a non-transitory computer readable medium resides on the computing device, programmed to determine the text messages to be sent to the user based on the user's goal and responses to pull messages. The non-transitory computer readable medium is further configured to solicit the personal information from the user by sending pull messages to the user, tailor the push messages sent to the user with the personal information gained from the pull messages, and motivate the user to meet a weight loss goal by adjusting the language of the pull and push messages based on the personal information and elicited feedback from the user.

### BRIEF DESCRIPTION OF THE DRAWINGS

The accompanying drawings provide visual representations, which will be used to more fully describe the representative embodiments disclosed herein and can be used by those skilled in the art to better understand them and their inherent advantages. In these drawings, like reference numerals identify corresponding elements and:

FIG. 1 illustrates a schematic diagram of a framework for transmitting motivational messages to a user according to an embodiment of the invention.

FIG. 2 illustrates a schematic diagram of a computing device according to an embodiment of the present invention.

FIG. 3 illustrates an exemplary structure for providing these motivational text messages to the user, according to an embodiment of the present invention.

FIG. 4 illustrates an image of an exemplary text message conversation with a user, according to an embodiment of the present invention.

FIG. 5 illustrates an image of an exemplary weekly weight check text message conversation with the user, according to an embodiment of the present invention.

FIG. 6 illustrates an exemplary list of predictors, according to an embodiment of the present invention.

FIG. 7 illustrates an exemplary questionnaire, according to an embodiment of the present invention.

### DETAILED DESCRIPTION

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

An embodiment in accordance with the present invention provides a system and a method for facilitating a user to meet a self-selected goal. The user enrolls in the program and receives a tailored series of motivational text messages. The text messages can be individualized for the user based on user goals, responses to pull text messages, responses to questionnaires, and the user's preferred style and timing of receiving information. These text messages help to guide the user to reach the goals by encouraging and reminding the user to engage in desired behaviors. The system and method are described with respect to an exemplary embodiment for encouraging weight loss, but can also be used for other applications, such as diabetes control and smoking cessation.

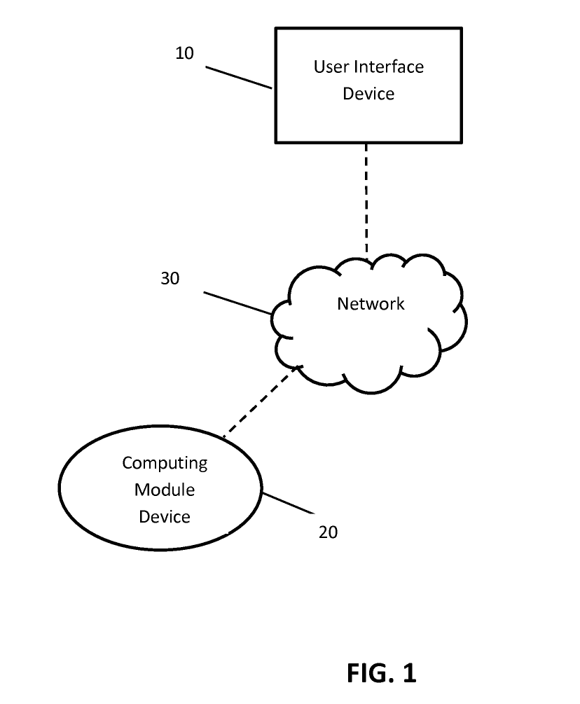

In one embodiment, illustrated in FIG. 1, the framework for transmitting motivational messages to a user can include a user interface device 10, and a computing device 20. The computing device 20 may be a general computing device, such as a personal computer (PC), a UNIX workstation, a server, a mainframe computer, a personal digital assistant (PDA), smartphone, cellular phone, a tablet computer, a slate computer, or some combination of these. Alternatively, the computing device 20 may be a specialized computing device conceivable by one of skill in the art. The remaining components may include programming code, such as source code, object code or executable code, stored on a non-transitory computer readable medium that may be loaded into the memory and processed by the processor in order to perform the desired functions of the system. The user interface device 10, which will be described in more detail herein, can include a cellular telephone, a smart phone, a tablet computing device, a pager, a PC computing device, or any other suitable device known to or conceivable by one of skill in the art.

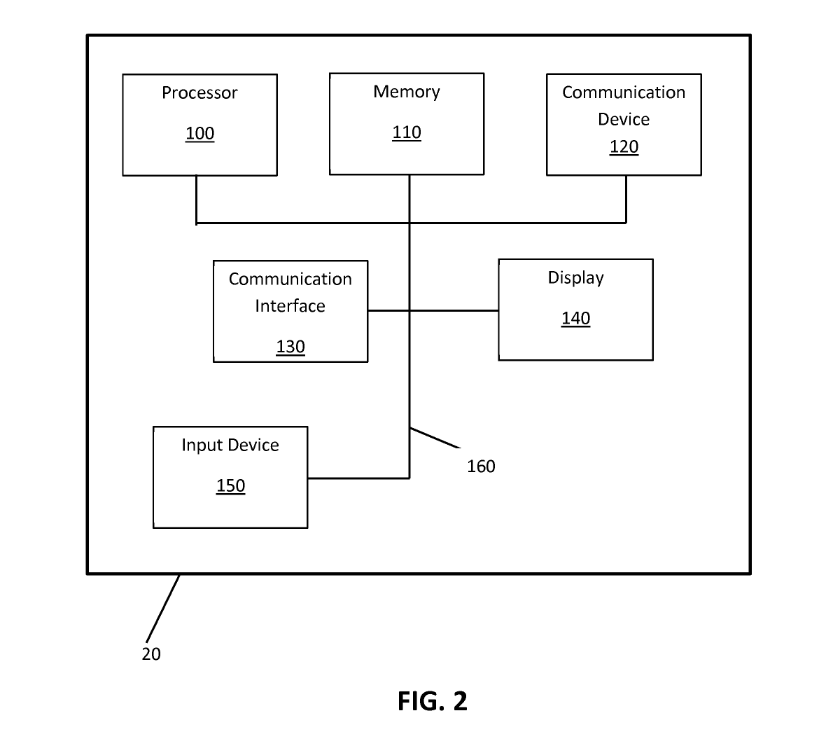

The user interface device 10 and the computing device 20 may communicate with each other over a communication network 30 via their respective communication interfaces as exemplified by element 130 of FIG. 2. The communication network 30 can include any viable combination of devices and systems capable of linking computer-based systems, such as the Internet; an intranet or extranet; a local area network (LAN); a wide area network (WAN); a direct cable connection; a private network; a public network; an Ethernet-based system; a token ring; a value-added network; a telephony-based system, including, for example, T1 or E1 devices; an Asynchronous Transfer Mode (ATM) network; a wired system; a wireless system; an optical system; cellular system; satellite system; a combination of any number of distributed processing networks or systems or the like.

Referring now to FIG. 2, the computing device 20 can each include a processor 100, a memory 110, a communication device 120, a communication interface 130, an input device 150, and a communication bus 160, respectively. The processor 100, may be executed in different ways for different embodiments of the computing device 20. One option is that the processor 100, is a device that can read and process data such as a program instruction stored in the memory 110, or received from an external source. Such a processor 100, may be embodied by a microcontroller. On the other hand, the processor 100 may be a collection of electrical circuitry components built to interpret certain electrical signals and perform certain tasks in response to those signals, or the processor 100, may be an integrated circuit, a field programmable gate array (FPGA), a complex programmable logic device (CPLD), a programmable logic array (PLA), an application specific integrated circuit (ASIC), or a combination thereof. Different complexities in the programming may affect the choice of type or combination of the above to comprise the processor 100.

Similarly to the choice of the processor 100, the configuration of a software of the user interface device 10 and the computing device 20 (further discussed herein) may affect the choice of memory 110 used in the user interface device 10 and the computing device 20. Other factors may also affect the choice of memory 110, type, such as price, speed, durability, size, capacity, and reprogrammability. Thus, the memory 110, of the computing device 20 may be, for example, volatile, non-volatile, solid state, magnetic, optical, permanent, removable, writable, rewriteable, or read-only memory. If the memory 110, is removable, examples may include a CD, DVD, or USB flash memory which may be inserted into and removed from a CD and/or DVD reader/writer (not shown), or a USB port (not shown). The CD and/or DVD reader/writer, and the USB port may be integral or peripherally connected to user interface device 10 and the computing device 20.

In various embodiments, user interface device 10 and the computing device 20 may be coupled to the communication network 30 (see FIG. 1) by way of the communication device 120. In various embodiments the communication device 120 can incorporate any combination of devices—as well as any associated software or firmware—configured to couple processor-based systems, such as modems, network interface cards, serial buses, parallel buses, LAN or WAN interfaces, wireless or optical interfaces and the like, along with any associated transmission protocols, as may be desired or required by the design.

Working in conjunction with the communication device 120, the communication interface 130 can provide the hardware for either a wired or wireless connection. For example, the communication interface 130, may include a connector or port for an OBD, Ethernet, serial, or parallel, or other physical connection. In other embodiments, the communication interface 130, may include an antenna for sending and receiving wireless signals for various protocols, such as, Bluetooth, Wi-Fi, ZigBee, cellular telephony, and other radio frequency (RF) protocols. The user interface device 10 and the computing device 20 can include one or more communication interfaces 130, designed for the same or different types of communication. Further, the communication interface 130, itself can be designed to handle more than one type of communication.

More particularly, the computing device is configured to transmit motivational messages to the user interface device. The nature of the messages, timing, and user input are all described further herein. The computing device setup described above allows the motivational messages to be delivered remotely, thereby reducing costs. The system is predominantly automated, and at its most basic, it requires no personnel efforts beyond user enrollment. In a preferred embodiment of the invention, text messages are used to deliver the motivational messages. These text messages are low cost for the user, use a technology and interface the user likely already has access to, and fit into a user's busy life without great burden. The system uniquely combines personalized user engagement, a strong evidence base, and cost effectiveness for tacking obesity and related lifestyle behaviors. The system can also be tailored to the user in a number of ways. Examples of how the system can be tailored to the user include, but are not limited to personalization to each user's self-reported behaviors, weight control goals, and daily routine, targeting relevant behaviors for each user. Additionally, the system can include personalized daily interactive messages that allow for the delivery of finely-tailored, adaptable, automatic feedback. These personalization tactics promote accountability and self-monitoring in the user. The system of the present invention is based on behavioral predictors that can be further individualized based on survey-type questions. It should also be noted that the present invention is configured to learn from and adapt based on the user's responses to the “pull” messages. For example, if the progress in making behavior changes is decreasing or stagnant, the present invention is configured to deliver messages that encourage and direct further efforts to correct the behavior.

An exemplary implementation of the system is described below. This example is not meant to be considered limiting, but is included merely to further illustrate the possibilities of the present invention. In an exemplary embodiment of the present invention a user can enroll in the program using a website, email, automated telephone program, or application on a computer, telephone, smartphone, or tablet. A server can be used to host a webpage, telephone program, or application. During enrollment, the user can answer a series of questions to determine the user's goals, desired weight loss, preferred learning method (i.e. visual, aural, written, and pictorial, etc.).

The present system utilizes messages that are informational, motivational, and “cues to action.” In addition, interactive “pull” messages promote accountability and self-monitoring by prompting the participants for their weight and quantifiable measures of healthy eating and exercise behaviors. For instance, a user can choose to work on a number of individual weight management challenges from several predefined goals, including, but not limited to the following: increase physical activity in daily life, increase planned exercise, better portion control, more balanced diet, reduced sugar intake, reduced fatty food consumption, eating only when hungry (i.e. avoiding inappropriate eating triggers). Text messages address the self-selected goals in a manner that allows the user to focus on the individual goals one at a time and then integrate them.

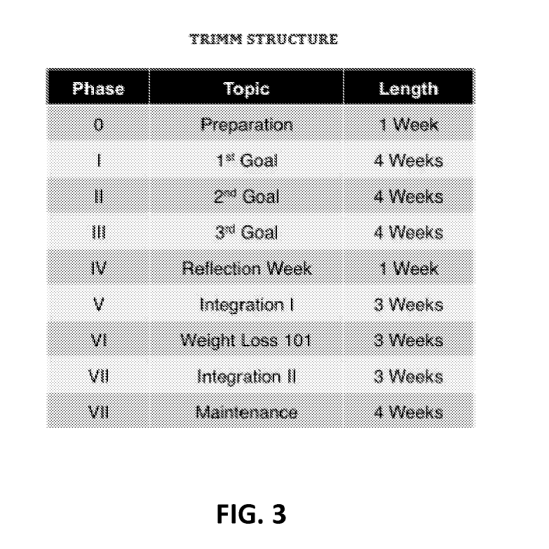

FIG. 3 illustrates an exemplary structure for providing these motivational text messages to the user. In the example illustrated in FIG. 3 the user has selected three goals to be addressed over a six month time period. There are seven phases that address topics such as preparation, the user's self-selected goals, reflection, integration, weight loss, and maintenance. These phases are addressed over a number of weeks, from one to four, depending on the depth of the topic.

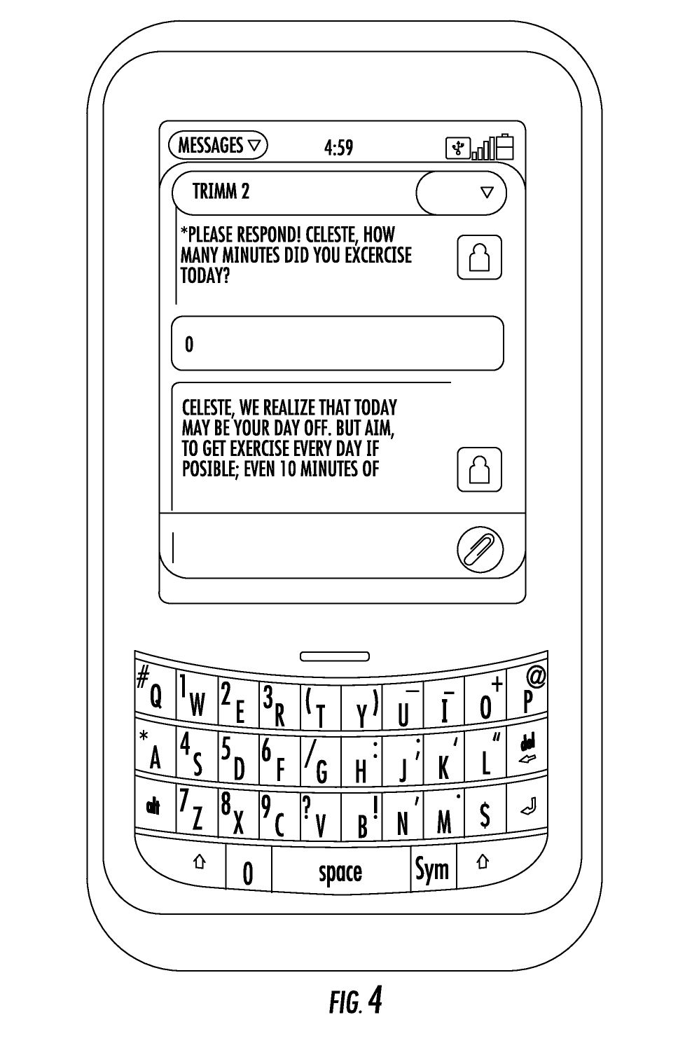

FIG. 4 illustrates an image of an exemplary text message conversation with a user, according to an embodiment of the present invention. Shown in FIG. 4 is an example of a “pull” message that prompts the user to respond. The exemplary pull message reads, “Please respond, Celeste, how many minutes did you exercise today?” The user response reads, “0.” This user response prompts a response that reads, “Celeste, we realize that today is your day off, but aim to get exercise everyday if possible, even 10 minutes of fast walking makes a difference.”

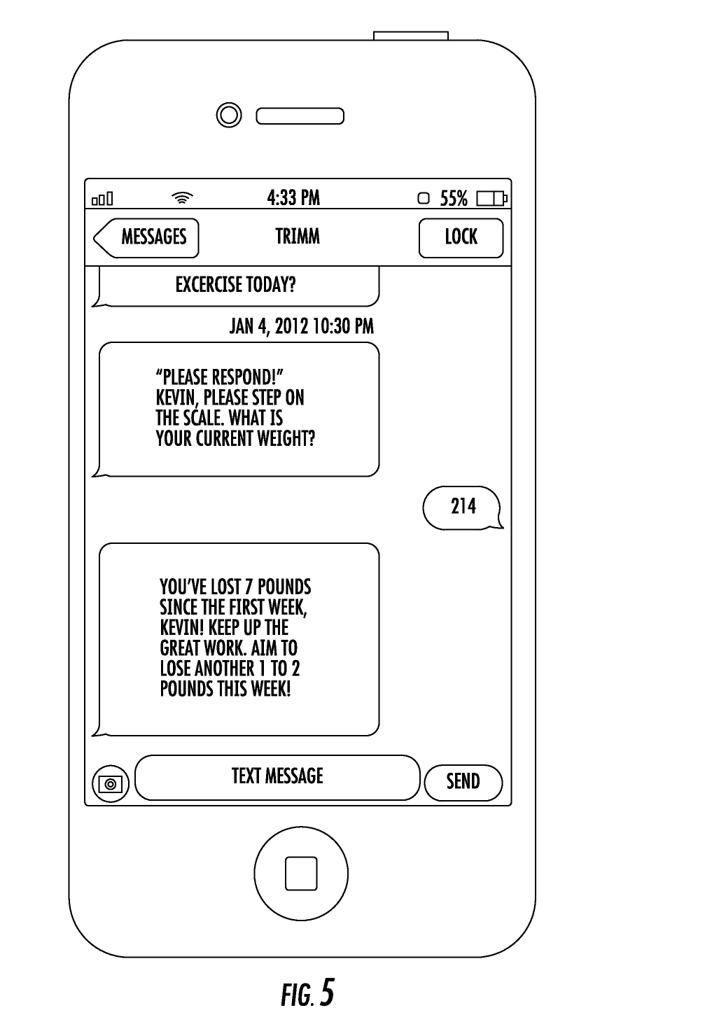

FIG. 5 illustrates an image of an exemplary weekly weight check text message conversation with the user. In the illustrated example, the weekly weight check occurs on Sundays. When a user responds with his or her weight, the system automatically calculates the weight loss compared to the starting week and sends an appropriate motivational message. The exemplary pull message reads, “Please Respond! Kevin, please step on the scale. What is your current weight?” The exemplary user response reads, “214.” The user response prompts a system response that reads, “You've lost 7 pounds since the first week, Kevin! Keep up the great work. Aim to lose another 1 to 2 pounds this week!”

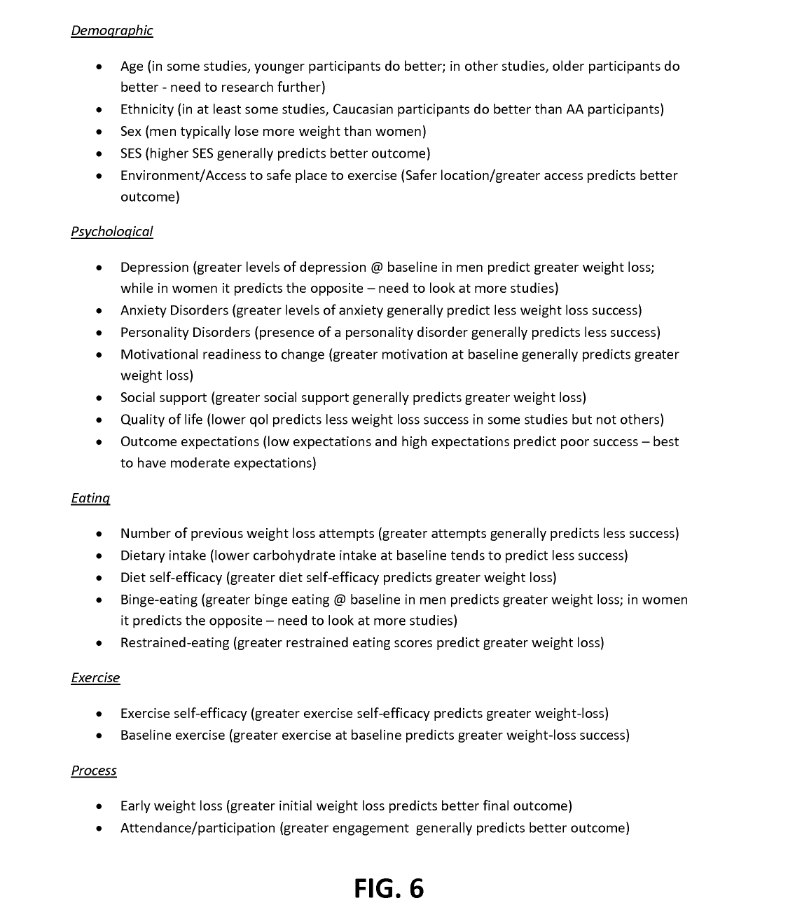

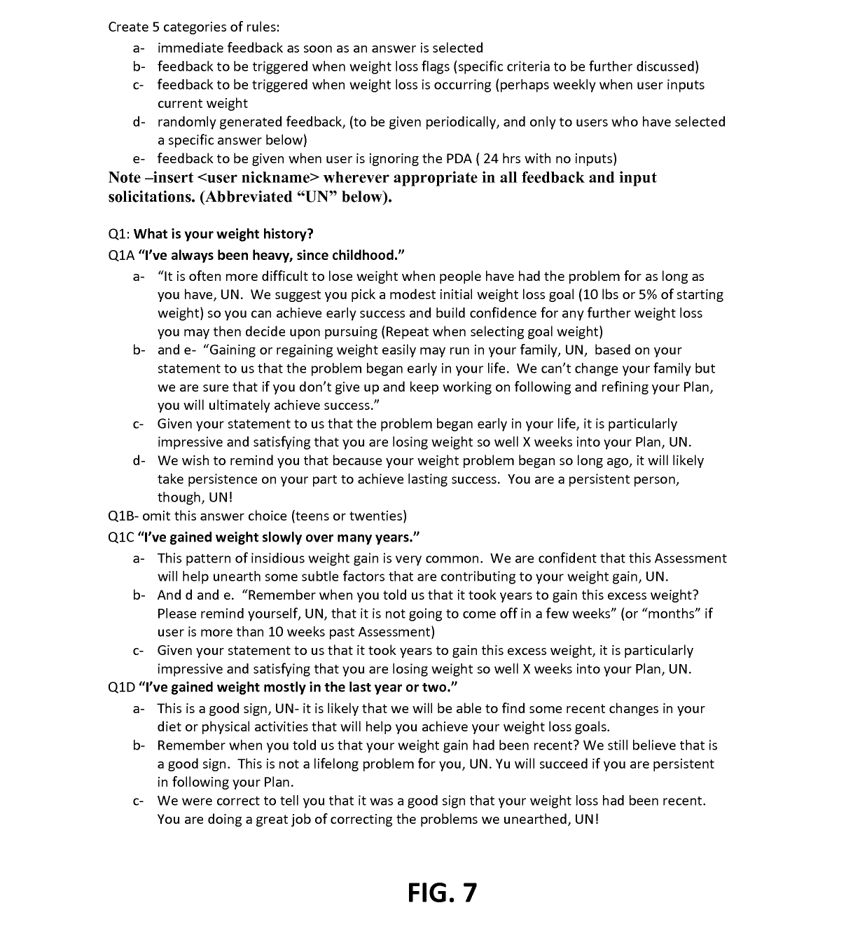

A library of pull text messages and response text messages can be created for the program being run on the computing device to send to the user, and is based on the user's selected goals, tenure in the program, and responses to pull text messages sent by the system. The text messages can be further personalized with the user's name and additional information about the user. The additional information about the user can be obtained in many different ways known to one of skill in the art, such as through pull messaging and questionnaires provided to the user via mail, internet input, phone, in-person, and other means throughout the course of the program. Also, message content can be based on predictive measures for weight loss, based on the user's age, gender, goals, responses to pull messaging, and responses to questionnaires. An exemplary list of these predictors is included as FIG. 6. In this way, the program can target and individualize based on predictors. In some embodiments, in order to streamline the personalization process, users can also be grouped into various categories based on the information associated with each user, in order to transmit text messages tailored to that category of users. Categories of users could be based on similar goals, gender, responses to pull messages, responses to questionnaires, or any other determinative factor known to or conceivable by one of skill in the art. An exemplary questionnaire is included as FIG. 7.

It should be noted that although the invention is described with respect to encouraging a weight loss goal, such a system could be used for many different kinds of goal-oriented situations. For example, such a system could be used for diabetes management or smoking cessation.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. Configuring a series of messages to motivate a user to lose weight, wherein said messages take the form of pull messages configured to request personal information from the user, and push messages configured to deliver personalized information to the user;
soliciting the personal information from the user by sending pull messages to the user;
tailoring the push messages sent to the user with the personal information gained from the pull messages;
motivating the user to meet a weight loss goal by adjusting the language of the pull and push messages based on the personal information and elicited feedback from the user.

2. Claim 1 further comprising using a questionnaire to solicit additional information from the user.

3. Claim 2 further comprising using the additional information to further tailor the push messages sent to the user.

4. Claim 2 further comprising designing the questionnaire to allow for the user to be placed in a category, such that the user receives text messages tailored to that category.

5. Claim 1 further comprising using predictive measures to determine the text messages sent to the user.

6. claim 1 further comprising using feedback from the user regarding a preferred style of receiving information to determine a format for the text messages sent to the user.

7. A method of promoting a goal for a user, comprising:
configuring a series of messages regarding the goal to be directed to the user, wherein said messages take the form of pull messages configured to request personal information from the user and take the form of push messages configured to deliver personalized information to the user;
soliciting the personal information from the user by sending pull messages from the series of messages to the user;
tailoring the push messages sent to the user with the personal information gained in the pull messages; and
motivating the user to meet a goal by adjusting the language of the push and pull messages based on the personal information from the user.

8. The method of claim 7 further comprising using a questionnaire to solicit additional information from the user.

9. The method of claim 8 further comprising using the additional information to further tailor the push messages sent to the user.

10. The method of claim 8 further comprising designing the questionnaire to allow for the user to be placed in a category, such that the user receives text messages tailored to that category.

11. The method of claim 7 further comprising using predictive measures to determine the text messages sent to the user.

12. The method of claim 7 further comprising choosing the goal as one selected from a group consisting of weight loss and related behaviors supportive of weight loss, diabetes control, and smoking cessation.

13. The method of claim 7 further comprising individualizing the user's text messages based on a preferred style of receiving information, predetermined by the user.

14. A system for helping a user to meet a goal comprising:
a computing device configured to transmit motivational text messages to the user;
a database including the motivational text messages to be sent to the user; and
a non-transitory computer readable medium residing on the computing device programmed to determine the text messages to be sent to the user based on the user's goals and characteristics, wherein the non-transitory computer readable medium is further programmed to:
solicit the personal information from the user by sending pull messages to the user;
tailor the push messages sent to the user with the personal information gained from the pull messages; and
motivate the user to meet a weight loss goal by adjusting the language of the pull and push messages based on the personal information and elicited feedback from the user.

15. The system of claim 14 further comprising using a questionnaire to solicit additional information from the user.

16. The system of claim 15 wherein the additional information is used to further tailor the push messages sent to the user.

17. The system of claim 15 wherein the questionnaire is designed to allow for the user to be placed in a category, such that the user receives text messages tailored to that category.

18. The system of claim 14 wherein the non-transitory computer readable medium is programmed to use predictive measures to determine the text messages sent to the user.

19. The system of claim 14 further comprising the goal being one chosen from a group consisting of weight loss and related behaviors supportive of weight loss, diabetes control, and smoking cessation.

20. The system of claim 14 wherein the non-transitory computer readable medium is programmed to individualize the user's text messages based on a preferred style of receiving information, predetermined by the user.
